(19) United States
(12) Patent Application Publication
(10) Pub. No.: US 2024/0014438 A1
(43) Pub. Date: Jan. 11, 2024

(54) High-Entropy Solid-State Electrolyte

(71) Applicant: WiSys Technology Foundation, Inc., Madison, WI (US)

(72) Inventor: Zhezhen Fu, Verona, WI (US)

(21) Appl. No.: 18/218,688

(22) Filed: Jul. 6, 2023

Related U.S. Application Data
(60) Provisional application No. 63/358,731, filed on Jul. 6, 2022.

(51) Int. Cl. H01M 10/0562

(52) U.S. Cl. CPC H01M 10/0562; H01M 2300/0071

(57) ABSTRACT

The present invention provides a novel high-entropy Li-garnet electrolyte with the chemical formula of Li₇La₃Zr_{0.5}Nb_{0.5}Ta_{0.5}Hf_{0.5}O₁₂, in which Zr, Nb, Ta, and Hf of equimolar amounts are on the Zr site in LLZO. The present invention also provides a novel method of manufacturing said high-entropy Li-garnet electrolyte.

### CROSS REFERENCE TO RELATED APPLICATION

This application claims the benefit of U.S. Provisional Application No. 63/358,731, filed Jul. 6, 2022, hereby incorporated by reference.

### STATEMENT REGARDING FEDERALLY SPONSORED RESEARCH OR DEVELOPMENT

--

### BACKGROUND OF THE INVENTION

The present invention relates generally to solid-state batteries and methods of making solid-state batteries and, in particular to, solid-state batteries that utilize Li-garnet solid-state electrolyte.

Solid-state batteries (SSBs) which utilize solid-state electrolyte (SSE) have attracted recent attention because they address the energy density and safety issues of traditional Li-ion batteries. By replacing the flammable organic electrolyte with a safer SSE, it has been found that one can minimize the safety issues associated with traditional Li-ion batteries. In particular, ceramic SSEs have attracted more and more attention for their applications in SSBs to improve energy density, decrease manufacturing costs, and fundamentally address the safety concerns in traditional Li-ion batteries.

High-entropy ceramics (>1.5 R) are formed from the theory of high-entropy alloys. The basic arrangement of high-entropy ceramics has at least four different equimolar elements on a single binding site. The entropy-stabilized oxide (Mg, Ni, Co, Cu, Zn)O exhibits a stabilized single phase with homogenous elements distributed at the atomic scale. Examples of high-entropy or medium-entropy ceramics include oxide, carbide, boride, and the like.

Processed ceramic materials show unique properties such as ultra-low thermal conductivity useful for the application of environmental barrier coatings, high mechanical properties useful for structural applications, and superior energy storage properties useful for battery applications (either cathode or anode). However, there are also unique structures or properties of high-entropy ceramic materials such as the sluggish diffusion effects which influence the grain growth and morphology, various vacancies/deficiencies which modify the matter transport, and lattice distortions due to the different atomic radii.

For this reason, the mechanical properties of the SSE play an important role in preventing lithium dendrite penetration and maintaining the integrity of the electrolyte for fast charging and long cycle life of the SSB. For example, during the charging and discharging cycles in SSBs, there are stresses applied to the SSEs, which originate from the lithium dendrite penetration. To withstand the high current and long-term cycling, it is desired that the SSEs be strong enough to ensure their integrity. However, ceramic solid-state electrolyte is normally brittle and easy to fracture under load, so it is necessary to improve the corresponding mechanical properties of these materials.

### SUMMARY OF THE INVENTION

Due to the unique structures of certain high-entropy ceramics, it is believed that high-entropy Li-garnet may have promising properties. The present invention has also found that using a highly specific Li metal cathode or anode can significantly improve the energy density of the battery.

Referring to FIG. 1, among the different ceramic SSEs, Li-garnet (LiₓLa₃M₂O₁₂, where x is in the range of 6-7, M=Zr, Ta, Nb, etc., M=Zr is the most studied one, LLZO) is one of the most promising candidates due to the adequate ionic conductivity (approaching 10⁻³ S/cm), good stability for handling and processing in air, wide electrochemical window (up to 5V), and promising mechanical properties. However, the ceramic is normally brittle with a low fracture toughness (about 1 MPa·m^{1/2}). The flexural strength also has a limitation of about 100-120 MPa.

It has been found that the properties of the Li metal anode are highly dependent on the doped elements, processing conditions, and microstructures. Therefore, for desirable applications of Li-garnet in SSBs, it is desirable to optimize such properties through doping engineering.

By introducing various dopants, the sintering behaviors, microstructures, electrochemical properties, and mechanical properties of Li-garnet can be modified to fulfill the requirements for the applications in SSBs. For instance, the introduction of Ta can increase the ionic conductivity to about 1.0×10⁻³ S/cm compared with undoped LLZO by stabilizing the cubic structure. The introduction of Ga can further increase the ionic conductivity to about 1.46×10⁻³ S/cm. The mechanisms of increasing the ionic conductivity include the stabilization of the cubic structure of Li-garnet, increasing Li occupancy at the distorted octahedral site, and expanding the bottleneck to create extra Li-ion transporting pathways.

The present invention provides a high-entropy solid-state electrolyte whereby the ability to dope multi-elements in the solid-state electrolyte can improve the properties, modify the microstructures, and eventually expand the design and processing of such materials.

The present inventors have found that the type of dopant along with the amount of dopant influences the phases, densification behaviors, microstructures, and eventually the properties (both electrochemical and mechanical properties) of the SSB.

The present invention provides a novel high-entropy Li-garnet electrolyte with the chemical formula of Li₇La₃Zr_{0.5}Nb_{0.5}Ta_{0.5}Hf_{0.5}O₁₂, in which Zr, Nb, Ta, and Hf of equimolar amounts are on the Zr site in LLZO. The present invention also provides a novel method of manufacturing said high-entropy Li-garnet electrolyte.

The present invention shows that Li₇La₃Zr_{0.5}Nb_{0.5}Ta_{0.5}Hf_{0.5}O₁₂(LLZNTH) high-entropy Li-garnet has a fine microstructure and improved mechanical properties compared to Ta-doped Li-garnet (Li_{6.75}La₃Zr_{1.75}Ta_{0.25}O₁₂, LLZT).

In one embodiment of the present invention is a solid-state battery comprising a Li-garnet ceramic electrolyte comprising a powder with a chemical composition of Li₇La₃Zr_{0.5}Nb_{0.5}Ta_{0.5}Hf_{0.5}O₁₂.

The powder may have an entropy greater than 1.5 R.

The powder can be densified to a density of about 93-94% at a temperature of about 1100° C.

The powder may have a fine grain size of about 1-10 μm.

Nb and Ta may be of equimolar amounts on the Zr site. Further, Zr and Hf may be of equimolar amounts on the Zr site.

The powder may have a single cubic garnet phase (space group: Ja3̅d; No. 230) with uniform elements distributions.

The powder can be densified to have an ionic conductivity of about 4.67×10⁻⁴ S cm⁻¹ at room temperature.

The powder can be densified to have an activation energy of about 0.25 eV or less.

The powder can be densified to have an electronic conductivity in the order of about 10⁻⁸ S cm⁻¹ or less.

The powder can be densified to have a flexural strength of at least 84.8±6.9 MPa.

The powder can be densified to have a hardness of at least 8.5±0.8 GPa.

One embodiment of the present invention provides a method of forming a solid-state battery comprising a Li-garnet ceramic electrolyte comprising: ball milling LiOH·H₂O (with 10% excess), La₂O₃, ZrO₂, Nb₂O₅, Ta₂O₅, and HfO₂ using milling media and liquid media to produce a mixture; drying the mixture at a low temperature; grounding the mixture; molding the mixture into pellets; and sintering the pellets at a high temperature. The ball milling may be for at least 24 hours. Drying the mixture may be at about 105° C. for 8 hours to 20 hours. Sintering of the mixture may be at about 1100° C. for 8 hours to 20 hours.

The method may further comprise forming a powder with the chemical composition of Li₇La₃Zr_{0.5}Nb_{0.5}Ta_{0.5}Hf_{0.5}O₁₂.

The milling media may be zirconia and the liquid media may be isopropyl alcohol (IPA).

The method may further comprise calcinating the pellets in an alumina crucible at about 900° C. for at least 12 hours. The method may further comprise ball milling using zirconia milling media in IPA after the calcinating step to reduce a particle size of the pellets.

These particular objects and advantages may apply to only some embodiments falling within the claims and thus do not define the scope of the invention.

### BRIEF DESCRIPTION OF THE DRAWINGS

FIG. 1 is a schematic illustration of the crystal structure of the present invention high-entropy Li-garnet electrolyte showing equimolar Zr, Nb, Ta, and Hf on the Zr site in LLZO;

FIGS. 2A-2F are characterizations of the synthesized LLZNTH powders: SEM micrographs of LLZNTH (2A) as calcined powder (2B) ball milled powder; LLZT (2C) calcined powder (2D) ball milled powder; (2E) particle size of the ball milled powders; (2F) XRD of the prepared powders after ball mill;

FIGS. 3A-3B are graphs showing TGA/DSC curves for the mixtures of (3A) LLZNTH, (3B) LLZT;

FIGS. 4A-4B are graphs showing XRD patterns of the sintered samples: (4A) LLZNTH samples sintered from 8 hours to 20 hours; (4B) LLZT samples sintered from 8 hours to 20 hours;

FIGS. 5A-5B are SEM micrographs and element distributions on the polished surface: (5A) LLZNTH sintered at 20 hours, (5B) LLZT sintered at 20 hours;

FIG. 6 is a graph showing relative density of the samples sintered between 8 and 20 hours;

FIGS. 7A-7D are fracture surface SEM micrographs of the LLZNTH sample sintered at (7A) 8 hours, (7B) 12 hours, (7C) 16 hours, (7D) 20 hours;

FIGS. 8A-8D are fracture surface SEM micrographs of the LLZT sample sintered at (8A) 8 hours, (8B) 12 hours, (8C) 16 hours, (8D) 20 hours;

FIGS. 9A-9E show the thermal etched surface of the LLZNTH sample: (9A) 8 hours, (9B) 12 hours, (9C) 16 hours, (9D) 20 hours, and (9E) grain sizes at different sintering times at a log-log scale plot;

FIGS. 10A-10C show the thermal etched surface of the LLZT sample: (10A) 8 hours, (10B) 12 hours, (10C) 16 hours;

FIGS. 11A-11B are graphs showing the mechanical properties of the sintered samples: (11A) Vickers hardness, (11B) Flexural strength; and

FIGS. 12A-12G are graphs showing the electrochemical properties of the samples: LLZNTH sample (12A-12D) AC impedance spectra, (12E) a summary of the ionic conductivity, (12F) Arrhenius plot, (12G) DC polarization plot for the sample sintered at 1100° C. for 16 h.

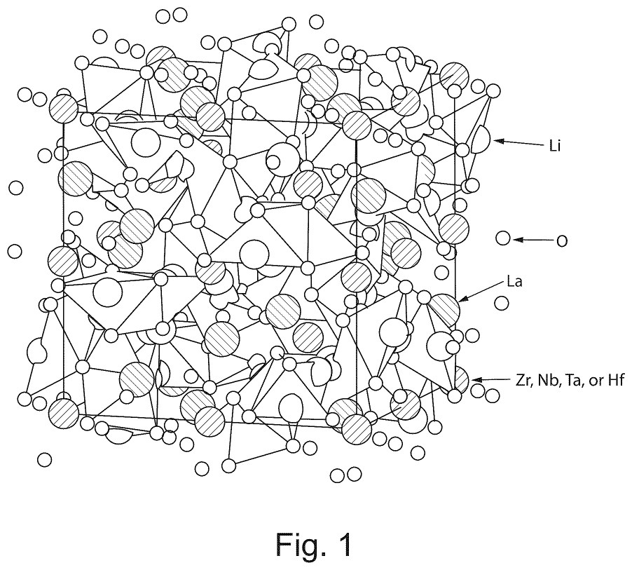

### DETAILED DESCRIPTION OF THE PREFERRED EMBODIMENT

### Background

The introduction of Al can stabilize the cubic phase Li-garnet to improve the ionic conductivity of the ceramic material. Other dopants in the Zr site, such as Ta, Nb, Te, and W, can also stabilize the cubic phase as well as produce a high ionic conductivity. However, prior art studies have only focused on single element doping. For example, the prior art focuses on single element doping on either the A site or B site, or A and B site co-doping with a single element on each site. There are few studies focused on doping multi elements on a single site.

Besides electrochemical properties, the type of dopant can influence the microstructures and mechanical properties of the ceramic material. For example, Ga-LLZO shows a mechanical strength of about 143 MPa and a fracture toughness of 1.22 MPa·m^{1/2}, which is higher than Al- and Ta-doped LLZO. Further studies indicate that the dopant type changes the microstructures such as grain size and grain boundary conditions and consequently the mechanical properties of the ceramic material.

A fine microstructure is anticipated to have higher hardness and flexural strength. The type of dopant also influences the stability against lithium metal. For example, Ta doped LLZO has much better stability against Li metal than Nb doped LLZO due to the reduction reaction of Nb dopant in the interface.

Besides the dopant types, the amount of dopant can also influence the structures and properties of the ceramic material. For example, studies have shown that the effects of Ta doping in Li₇₋ₓLa₃Zr₂₋ₓTaₓO₁₂ (LLZO) indicate that the optimal amount of Ta in LLZO is between 0.4 and 0.6.

To further improve the ceramic material's properties, novel doping strategies, such as co-doping, are necessary to continue to improve and tune the properties.

Therefore, the present inventors have found that it is desirable to optimize doping to further improve the ionic conductivity, enhance the stability against Li metal, and refine its microstructures for better mechanical properties.

### High-Entropy Li-Garnet Ceramic Electrolyte

High-entropy ceramics (HECs), initiated from high-entropy alloys, contain at least four different equimolar or near equimolar elements on the same site and show various unique properties. For instance, HECs show lower thermal conductivities than regular ceramics (including oxide and non-oxide ceramics) and have potential applications as thermal barrier coating and ultra-high temperature ceramics.

Carbide-based HECs show very promising oxidation resistance under elevated temperatures for high-temperature applications. HE carbide also has very good mechanical properties including hardness, flexural strength, and fracture toughness, which can be attributed to the unique microstructures including solid solution strengthening mechanism and nanoplate pullout along with microcrack deflection toughening mechanisms. It has been found that HE carbide has a lower grain growth rate than traditional carbide.

The present invention provides a novel Li₇La₃Zr_{0.5}Nb_{0.5}Ta_{0.5}Hf_{0.5}O₁₂ high-entropy Li-garnet ceramic electrolyte having desirable electrochemical properties as well as unique super fine microstructures. The equimolar doping of Ta and Nb (Li₆₄La₃Zr_{1.4}Ta_{0.3}Nb_{0.3}O₁₂) has a higher ionic conductivity than non-equimolar ones (Li₆₄La₃Zr_{1.4}Ta_{0.5}Nb_{0.1}O₁₂ and Li_{6.4}La₃Zr_{1.4}Ta_{0.4}Nb_{0.2}O₁₂). The equimolar ratio of the dopants (Zr, Nb, Ta, and Hf) leads to desirable electrochemical properties, and the desirable fine microstructures can be attributed to the sluggish effects of high-entropy compounds. The unique fine microstructures with high grain boundary strength can alter and improve the mechanical properties of the ceramic material including hardness, fracture toughness, and flexural strength. For example, the high-entropy Li-garnet has a higher hardness than the traditional Li-garnet.

The high-entropy Li-garnet shows very promising electrochemical properties, which indicates its potential applications in SSBs. Computational research indicates the possibility to result in a higher ionic conductivity through the high-entropy approach. Electrochemical characterizations indicate that the higher density sample has an adequate ionic conductivity of 4.67×10⁻⁴ S cm⁻¹ at room temperature, a low activation energy of 0.25 eV, and a low electronic conductivity in the order of 10⁻⁸ S cm⁻¹.

Mechanical properties of Li-garnet play vital roles in preventing Li penetration during charge and discharge in SSBs. The mechanical properties of Li-garnet are highly dependent on the microstructures. For instance, finer grain size and strong grain boundaries can lead to higher mechanical properties. HECs have abnormal grain growth behaviors and consequently unique microstructures. Thus, the HE Li-garnet may have unique sintering behaviors and consequently different mechanical properties as well.

The present invention also provides for the synthetization of LLZNTH Li-garnet powders which has a single cubic garnet phase (space group: Ia3̅d; No. 230) without any secondary phases, as well as uniform element distribution. The prepared powders are further densified to a relative density of about 94% with well crystallized grains and good contact area with the neighboring grains. Minimal grain growth can be observed in the sintering time range from 8 hours to 20 hours, which is believed to be due to the sluggish effects of high-entropy compounds. The sample also maintains the cubic garnet phase along with uniform elements distribution after sintering.

Therefore, the present invention provides for the processing of single phase Li₇La₃Zr_{0.5}Nb_{0.5}Ta_{0.5}Hf_{0.5}O₁₂ high-entropy Li-garnet electrolyte with the following desirable properties:
1. Four equimolar ratio elements of Zr, Nb, Ta, and Hf successfully doped into the Zr site of Li-garnet and the synthesized material has a single cubic garnet phase (space group: Ia\hat{3}d; No. 230) with uniform elements distributions.
2. The powders may be densified to a relative density up to 94% with relatively fine grain size of about 1-10 μm. The grain growth rate is minimal with the elongation of the sintering time from 8 hours to 20 hours. The sintered samples maintain the single cubic phase with uniform elements distributions at the micrometer scale.
3. The sintered samples have promising electrochemical properties including an ionic conductivity of 4.67×10⁻⁴ S cm⁻¹, an activation energy of about 0.25 eV, and a low electronic conductivity in the order of 10⁻⁸ S cm⁻¹.

Li₇La₃Zr_{0.5}Nb_{0.5}Ta_{0.5}Hf_{0.5}O₁₂(LLZNTH) high-entropy Li-garnet has a fine microstructure and improved mechanical properties compared to Ta-doped Li-garnet (Li_{6:75}La₃Zr_{1.75}Ta_{0.25}O₁₂, LLZT). The formation, sintering, and electrochemical properties indicate that the LLZNTH sample has a finer particle size than LLZT after calcination and ball milling. Thermal gravimetric analysis (TGA) and differential scanning calorimetry (DSC) regarding the solid-state reaction process indicate that the LLZNTH forms at a lower temperature than LLZT. Both samples can be densified to a relative density up to about 93-94% at a temperature of about 1100° C., however, they show significantly different sintering and grain growth behaviors. The LLZNTH sample takes 16 hours to reach the maximum relative density while the LLZT sample only needs 12 hours.

LLZNTH sample has a lower grain growth parameter due to the sluggish effects of high-entropy compounds so that it maintains fine microstructures (grain size about 10 μm) than the LLZT sample (grain size over 100 μm). Due to the fine microstructures, the LLZNTH sample shows both higher flexural strength (84.8±6.9 MPa compared with 47.9±10.1 MPa) and hardness (8.5±0.8 GPa compared with 7.7±0.4 GPa) than the LLZT sample. Ionic conductivity characterizations indicate that the LLZNTH sample shows a moderate conductivity of 4.67×10⁻⁴ S/cm at room temperature and a low activation energy of 0.25 eV.

The sintering, microstructures, mechanical properties, and electrochemical properties of high-entropy Li₇La₃Zr_{0.5}Nb_{0.5}Ta_{0.5}Hf_{0.5}O₁₂ were compared to the results with Li_{6:75}La₃Zr_{1:75}Ta_{0.25}O₁₂ and show:
1. High-entropy LLZNTH is of a single Li-garnet cubic phase and has a finer particle size and a lower formation temperature than LLZT.
2. LLZNTH can be densified to a relative density of about 94.1% at a temperature of about 1100° C. for 16 hours, which is slightly longer than LLZT's 12 hours. This can be attributed to the sluggish diffusion effects of high-entropy compounds.
3. LLZNTH follows the typical grain growth behavior from the sintering time of 8 hours to hours, and the grain size increases from about 2.35 μm to about 4.57 μm with the increase of the sintering time, which is much finer than the LLZT sample. LLZT has abnormal grain growth behavior after the sintering time of 12 hours and some large grains are over 100 μm.
4. Due to the fine grain size, LLZNTH has promising mechanical properties including hardness of about 8.5±0.8 GPa and flexural strength of about 84.8±6.9 MPa, which are both higher than LLZT samples (about 7.7±0.4 GPa and about 47.9±10.1 MPa, respectively).
5. LLZNTH has an adequate ionic conductivity of about 4.67×10⁻⁴ S/cm and activation energy of 0.25 eV with a sintering time of 16 hours.

The following non-limiting examples illustrate the compositions, methods, and applications of the present teachings.

### EXAMPLES

1. Experiment

Powder Synthesis

The powders (high-entropy LLZNTH powders with the chemical composition of Li₇La₃Zr_{0.5}Nb_{0.5}Ta_{0.5}Hf_{0.5}O₁₂ and Ta doped Li-garnet powders, LLZT, with the chemical composition of Li_{6.75}La₃Zr_{1.75}Ta_{0.25}O₁₂) were prepared through a solid-state synthesis method described herein.

Stoichiometric amounts of LiOH·H₂O with 10% excess (Li is easy to evaporate during synthesis and sintering therefore excess amount was added, 98% minimum purity, Thermo Scientific), La₂O₃ (99.9% purity, Tokyo Chemical Industry America, dried at 950° C.), ZrO₂ (99.9% purity, Inframat Advanced Materials), Nb₂O₅ (99.9% purity, Alfa Aesar), Ta₂O₅ (99.99% purity, Inframat Advanced Materials), and HfO₂ (99%, Thermo Scientific) were ball milled for about 24 hours using zirconia milling media and isopropyl alcohol (IPA, 99.9% purity, Alliance Chemical) as the liquid media. The mixture was dried at about 105° C., ground, and pressed into pellets, as further described below.

To study the formation behaviors of the two different samples (LLZNTH and LLZT), the mixed precursors were subjected to TGA and DSC tests from room temperature to about 1050° C. with a heating rate of about 10° C./min under argon flowing (Perkin Elmer Thermal Analyzer 6000, Waltham, MA). The microstructures of the powders before and after the ball mill were characterized by a scanning electron microscope (SEM, SU1510, Hitachi) equipped with energy-dispersive X-ray spectroscopy (EDS, QUANTAX 100, Bruker). Phases and particle size of the powders were characterized by X-ray diffraction (XRD, D8 Discovery, Bruker) and a particle size analyzer (Mastersizer 2000, Malvern Instruments Limited), respectively.

Sample Densification and Characterizations

The produced powders were uniaxially pressed into pellets with a diameter of either about 13 mm (for microstructure and electrochemical characterizations) or about 30 mm (for mechanical properties tests) under pressure of about 120 MPa. The green pellets were surrounded by the same powder and placed in an alumina crucible with a lid to minimize the evaporation of Li during sintering. To find out the appropriate sintering conditions, the samples were sintered at about 1100° C. for about 8, 12, 16, and 20 hours in the air atmosphere. The heating and cooling rates were about 3° C./min.

Calcination occurred in an alumina crucible at about 900° C. for about 12 hours. Subsequent about 24 hours ball milling using zirconia milling media in IPA after the calcination was employed to reduce the particle size.

The samples were ground into powders and subjected to XRD and Raman (DXRxi Raman Imaging Microscope, Thermo Fisher Scientific) characterizations. The fracture surface of the sample was observed under SEM. The samples were also polished down to a finishing surface of 0.5 pin to observe the polished surface along with elements distribution/mapping under SEM equipped with EDS.

The sintered samples were ground to remove any coved powder bed. The density of the sintered sample was determined through Archimedes' method using IPA as the immersing medium. Relative density was calculated based on the theoretical density which was obtained from the molecular weight and lattice parameter. The sintered samples were also broken and ground into powders for XRD characterizations. The fracture surface of the sample was observed under SEM. The samples were also polished down to a finishing surface of 0.5 μm to observe the polished surface along with elements distribution/mapping under SEM equipped with EDS. The polished samples were also thermally etched at a temperature between about 800 to 1000° C. for a duration of about 5 to 30 minutes for different samples to observe the grain size. The grain size was determined through the intercept method using the ImageJ software package.

Mechanical Properties Characterizations

The samples were subjected to the 3-point bending test following ASTM C1161. The sintered large pellets were cut and then polished down to the desired dimension (2×1.5×25 mm) by controlling the polishing time with a surface finishing of 1 μm using diamond paste. The tests were performed on a mechanical tester (C43.504, MTS Systems Corporation) utilizing an attached 3-point bending fixture with a support span size of 20 mm. The crosshead speed was 0.2 mm/min. The flexural strength a was calculated as below:

$$σ = \frac{3 PL}{2 {bd}^{2}}$$

where P is the break force, L is the support span size (20 mm), b is the sample width (2 mm), and d is the sample thickness (1.5 mm).

The samples were also subjected to the Vickers hardness test. The samples were polished down to a finishing surface of 0.5 μm and cleaned with IPA to remove any residual contaminations. The hardness tests were performed using a Buehler Vickers hardness tester under a load of 500 g. At least 10 tests were performed on each sample to obtain mean and standard deviation values.

Electrochemical Properties Characterizations

Li-ion blocking silver paste was applied on the polished samples and fired at about 700° C. for about 0.5 hours to ensure a good interface. The ionic conductivity of each sample was determined by electrochemical impedance spectroscopy (EIS, Reference 3000, Gamry Instruments) in a frequency range of about 1 MHz to 1 Hz using the potentiostatic EIS model with an about 100 mV amplitude. The results were fitted using a proper equivalent circuit model to obtain the ionic conductivity.

2. Results and Discussion

Characterization of the Synthesized Powders and the Formation Behaviors

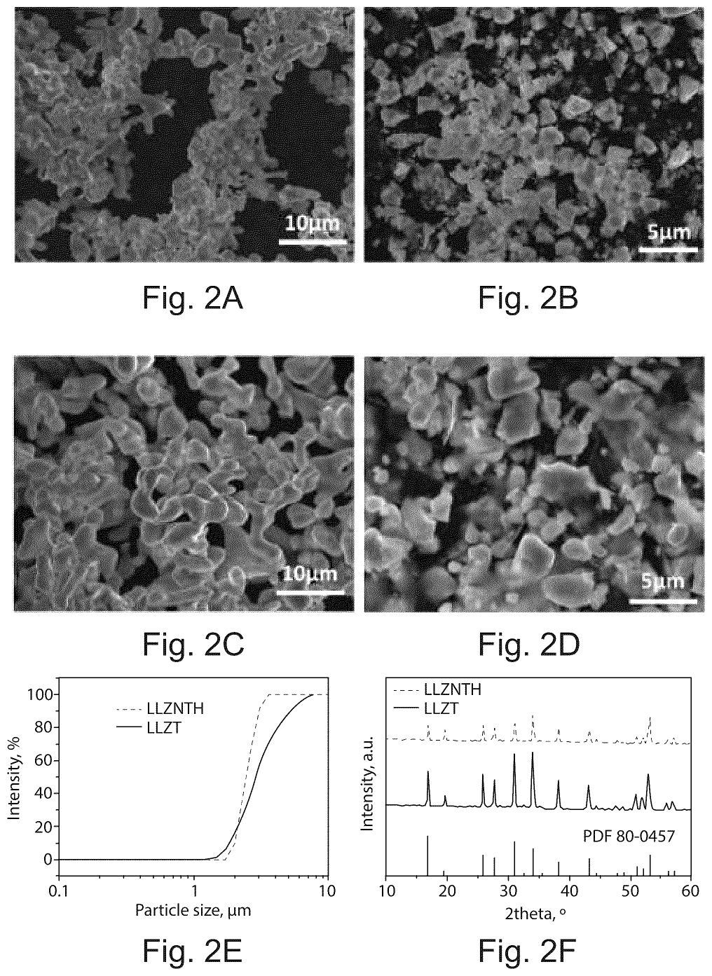

FIG. 2 shows the characterizations of the synthesized LLZNTH powders. FIGS. 2A and 2B show the microstructures of the LLZNTH powders after the calcination and ball mill, respectively. After calcination, the particles are agglomerated with a particle size from about 0.5 to 3 μm. After the ball mill, the particles are loosely agglomerated, and the particles are reduced to a size of about 0.1 to 2 μm with faceted morphologies. FIGS. 2C) and 2D are the SEM micrographs of the LLZT samples after calcination and ball mill. The calcinated LLZT powders are highly agglomerated by necking between particles and the particle size is about 0.5 to 5 μm. After the ball mill, the powders have a particle size of about 0.2 to 3 μm with round morphologies.

Particle size analysis on the ball-milled powders in FIG. 2E indicates that the LLZNTH sample has a D50 of about 2.5 μm and a D90 of about 3.0 μm while the LLZT sample has a D50 about 2.9 μm of and a D90 of about 5.2 μm. Compared between the two samples, the calcinated LLZNTH sample has a finer particle size than the LLZT sample, which is likely due to the sluggish diffusion effects of the high-entropy compounds. During the calculation/reaction, the sluggish diffusion effects can hinder the particle growth therefore the finer particle size for the LLZNTH sample. Meanwhile, because of the finer load size for the ball mill, the LLZNTH powder has a finer particle size and a narrow distribution than the LLZT powder after the ball mill. The finer particle size is beneficial for the following sintering process, as discussed below. Both samples show a single cubic garnet phase (with a comparison of PDF card #80-0457, space group: Ia 3 d; No. 230) after the ball mill, as shown by the XRD patterns in FIG. 2F.

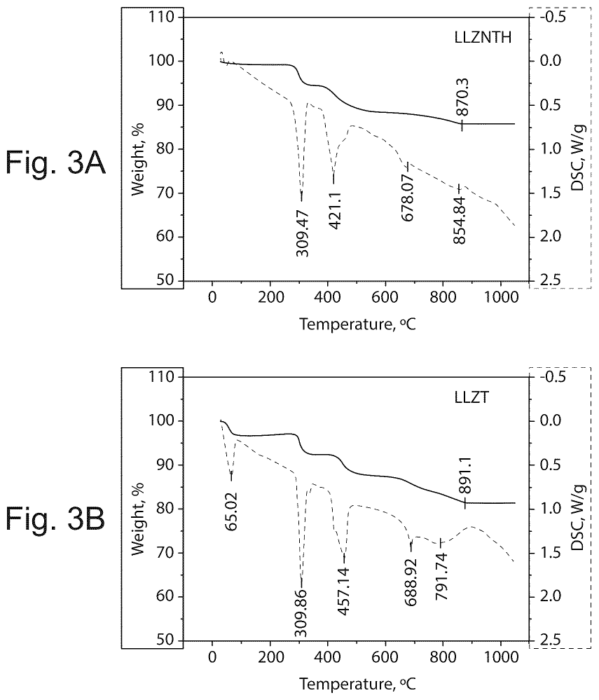

The formation temperatures of both samples were compared through TGA/DSC. As shown in FIG. 3, the formation and reaction processes for both samples are very similar, as indicated by the peaks in DSC and the weight loss procedures in TGA. The peaks and weight loss between about 300-500° C. can be attributed to the decomposition and associated evaporation from the raw materials (mainly LiOH·H₂O). There is a plateau, above between about 500° C. and about 670° C., followed by continuous reactions until about 900° C. (reactions peaks from DSC and weight loss from TGA) to lead to the formation of the Li-garnet. These samples have different final temperatures. After a temperature of about 870.3° C., no further weight loss can be observed for LLZNTH. However, for LLZT, the final temperature is about 891.1° C. Thus, LLZNTH can form at a slightly lower temperature than LLZT. Meanwhile, both temperatures are lower than the calcination temperature (about 900° C.), which further indicates the formation of a single-phase Li-garnet. It is hypothesized that the different formation temperatures may contribute to the different particle sizes of the calcinated powders, as shown in FIGS. 2A and 2C. Meanwhile, there is no change in TGA and DSC up to a temperature of about 1050° C., which indicates good thermal stability under high temperatures.

Sintering Properties of the Samples

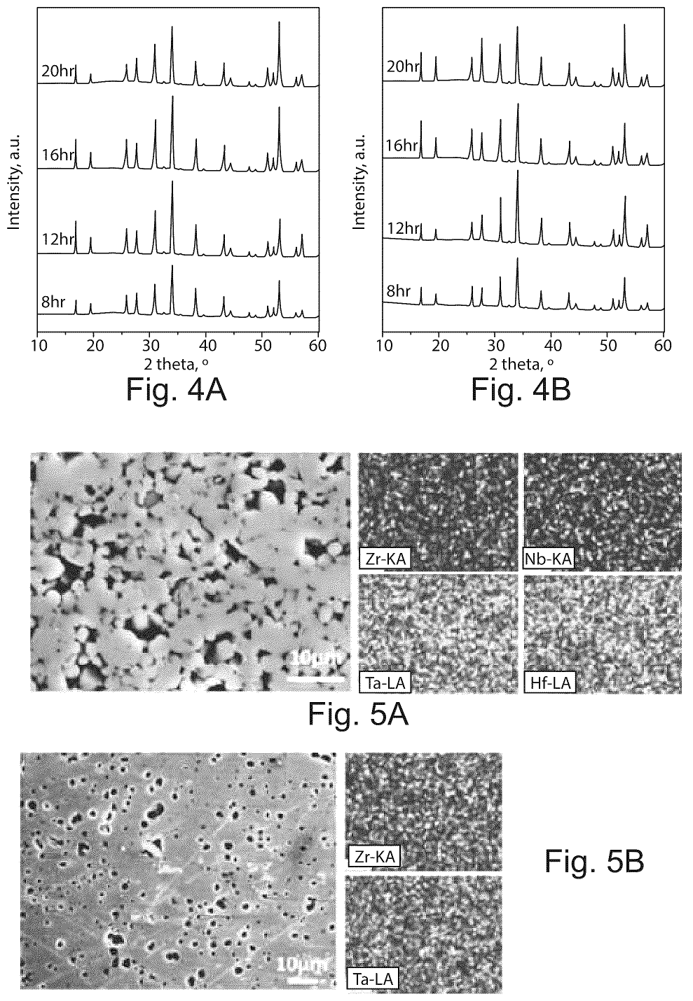

FIG. 4 shows the XRD patterns of the sintered samples. Both the LLZNTH and the LLZT samples show a single cubic garnet phase after sintering from about 8 to 20 hours. No secondary phase can be observed from the XRD patterns. As indicated in FIG. 5A, the LLZNTH shows uniform element distributions, and no concentration of all four doping elements at the micrometer scale after about 20 hours of sintering can be observed. Correlating with the XRD results, this further indicates the formation of the single-phase high-entropy LLZNTH, and thus, the LLZNTH sample has good thermal stability at a temperature of about 1100° C. for about 20 hours, which is consistent with the TGA/DSC results. No decomposition can be observed under such sintering conditions. The LLZT sample shows a similar element distribution as shown in FIG. 5B as well.

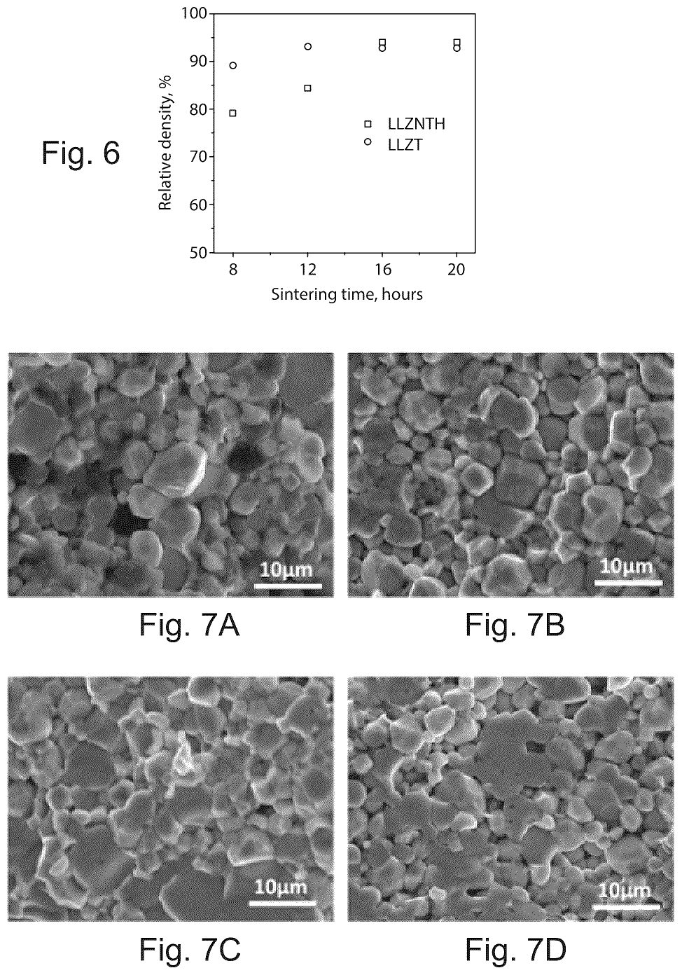

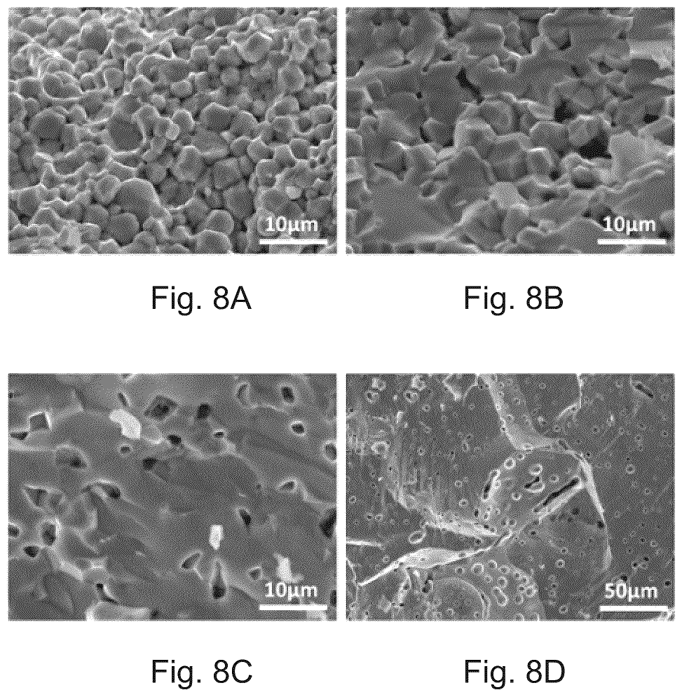

The density from Archimedes' method and the corresponding relative density (percentage of the theoretical density) is shown in FIG. 6. FIGS. 7 and 8 show the fracture surface SEM micrographs at various sintering durations. Both samples show the typical microstructure evolution of the densification process, which is consistent with the relative density changes as indicated in FIG. 6.

At a short sintering time (about 8 hours), the densification starts, and minimal grain growth can be observed for both samples, compared with the original particle size. The pores are mainly near the grain boundaries for both samples (FIG. 7A and FIG. 8A. The relative density is about 79.3% and about 89.1% for LLZNTH and LLZT samples, respectively. With the sintering temperature increased from about 8 to 16 hours, the LLZNTH sample continues densifying (a relative density of about 84.5%) with neglectable grain growth. Pores are eliminated due to the densification process and the corresponding density increases to a peak value of 94.1%, as indicated in FIG. 7C. Further increase of the sintering time to about 20 hours leads to the formation of a small number of trapped pores within the grains due to the grain growth and consequently the relative density slightly decreases (about 93.8%). For the LLZT samples, pores are eliminated and therefore the relative density increases to a peak of about 93.1% with a sintering time of about 12 hours. Continuous elongation of the sintering time leads to more obvious grain growth and a significant number of trapped pores within the grains (FIGS. 8C and 8D). The trapped pores lead to the decrease of the relative density to about 92.8% and about 93% for about 16 and 20 hours.

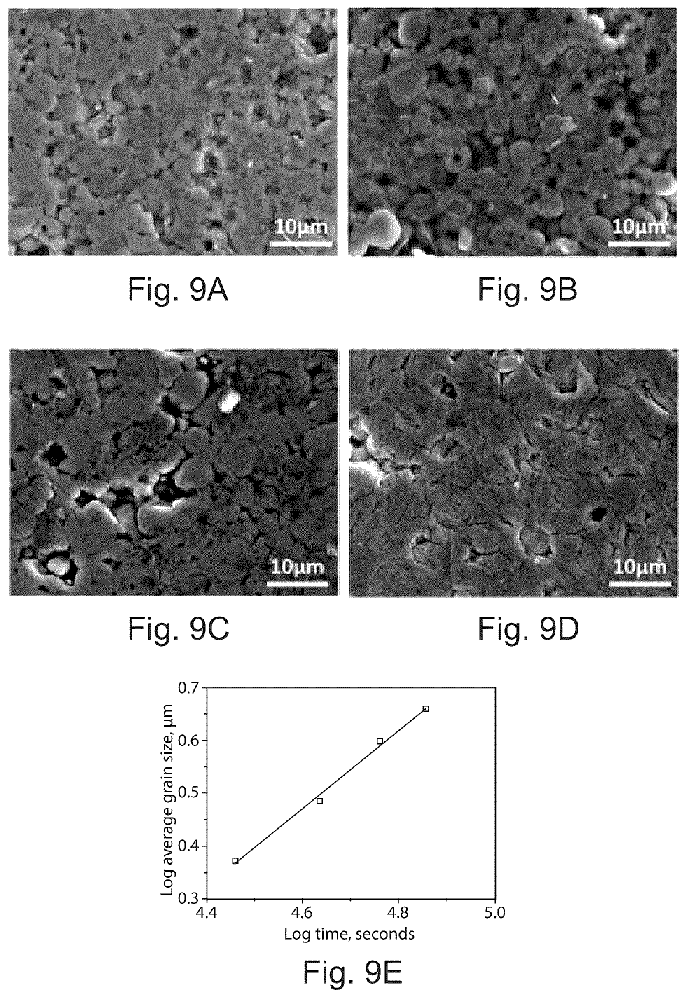

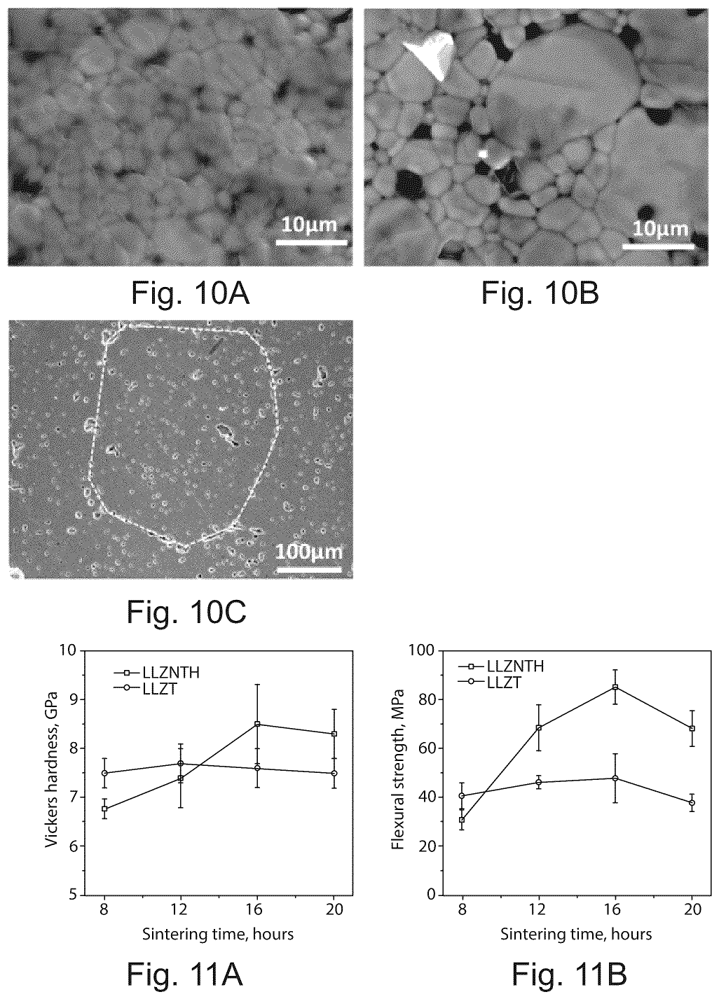

FIG. 9 shows the micrographs of the thermally etched surface and the corresponding grain size at different sintering durations for the LLZNTH sample. It is observed that the grain size increases from about 2.35 μm to about 4.57 μm with the increase of the sintering time from about 8 hours to about 20 hours at a temperature of about 1100° C. Furthermore, as shown in FIG. 9E, the grain size over time in a log-log scale plot can be linearly fit, which is a very typical ceramic material grain growth behavior. For the LLZT sample (fracture surface in FIG. 8 and thermally etched surface in FIG. 10), however, the clear grain boundaries were hardly observed when the sintering time is over about 12 hours. Some abnormally grown grains were found with a sintering time of about 16 hours, as highlighted in FIG. 10C. The grain size over time was linearly fit in a log-log scale plot for the LLZT sample due to the abnormal grain growth.

Comparing between the two samples, the differences in the sintering behaviors and microstructures can both be attributed to the sluggish diffusion effects of the high-entropy compounds (LLZNTH). The LLZT sample needs a shorter time to reach the peak density than the LLZNTH sample (about 12 hours against about 16 hours). Although the finer particle size of LLZNTH can increase the driving force of densification, the lower rate of diffusion hinders the densification process therefore a longer sintering time is necessary to reach the peak density. The sluggish diffusion effect also detracts the grain growth so no abnormal grains form after densification. However, for the LLZT sample, some grains significantly grew during the sintering process possibly due to the high rates of diffusion and grain boundary migration. Therefore, some significantly grown grains can be observed when the sintering time is over about 12 hours. The differences in the grain growth behaviors lead to completely different microstructures including grain size, grain boundary strength, fracture model, etc. Such differences can lead to different mechanical and electrochemical properties.

Mechanical and Electrochemical Properties

FIG. 11 shows the mechanical properties of the sintered LLZNTH and LLZT samples. As indicated in FIG. 11A, the hardness of LLZNTH increases from about 6.8±0.2 GPa to a peak number of about 8.5±0.8 GPa as the sintering time extends from about 8 hours to about 16 hours. Further sintering at about 20 hours slightly decreases the hardness to about 8.3±0.5 GPa. The LLZT sample shows a similar trend but fewer changes. Meanwhile, the peak number is only about 7.7±0.4 GPa at a sintering time of about 12 hours. Such results are in good consistency with the relative density and grain size of the samples as mentioned above. The increase in the relative density leads to a high hardness. However, a longer sintering time decreases the hardness due to grain growth. Meanwhile, the LLZNTH sample shows a higher peak hardness than the LLZT sample. This can be attributed to the fine grain size of about 3.96 μm and highly dense packed grains of the LLZNTH sample at the sintering time of about 16 hours, as discussed above. The values are also comparable with the literature-reported hardness of Li-garnet (about 6.5 to 10.3 GPa).

Flexural strength has a similar trend, as shown in FIG. 11B. The strength of the LLZNTH sample increases from about 30.8±4.1 MPa to about 84.8±6.9 MPa, as the sintering time increases from about 8 hours to about 16 hours. Further sintering of about 20 hours decreases the strength to about 60.8±7.5 MPa. For the LLZT sample, the flexural strength increases from about 40.6±5.3 MPa to about 47.9±10.1 MPa, and then decreases to about 37.7±3.5 MPa, with the increase of the sintering time from about 8 to about 20 hours. The changes in the strength can also be attributed to the evolution of the relative density and microstructures. The increase of the relative density increases the flexural strength while larger grains lead to a lower strength.

The LLZNTH sample shows higher mechanical properties than the LLZT samples, which can be attributed to the very fine grain size than that of the LLZT sample due to the sluggish effects of high-entropy compounds. The sluggish effect of the high-entropy compounds can slow the grain growth as discussed above, thus improving the mechanical properties including hardness and flexural strength.

Mechanical properties of the Li-garnet play vital roles in the development of SSBs. For instance, higher hardness and strength can more efficiently prevent lithium penetration during charge and discharge which can improve the durability of the battery for long-term use. Higher strength can also ensure the structural integrity of the electrolyte during the processing and assembling of the batteries. It is necessary to maintain the high mechanical properties of the SSEs. Meanwhile, different grain sizes may also influence the resistance to lithium penetration. The finer the grain size, the longer the penetration path along the grain boundaries, therefore higher resistance to lithium penetration.

It is hypothesized that the LLZNTH samples with finer grain sizes and higher mechanical properties may also have a higher resistance to lithium penetration. Furthermore, the high-entropy concept in ceramic SSEs can modify the ionic conductivity, the electrochemical window against Li metal, and interface stabilities, thus, high-entropy ceramic electrolytes may have more potential applications in SSBs.

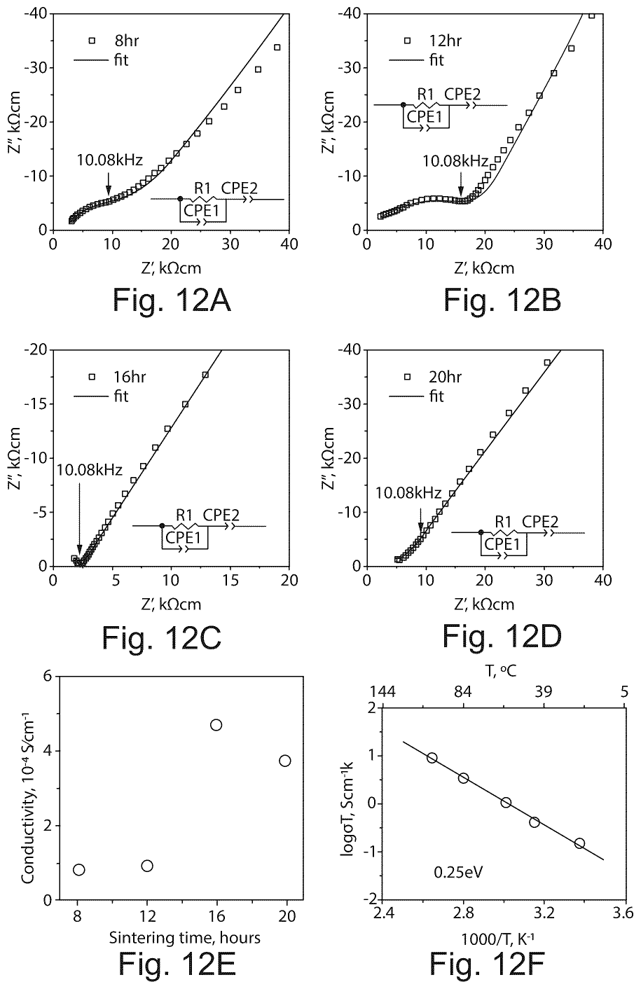

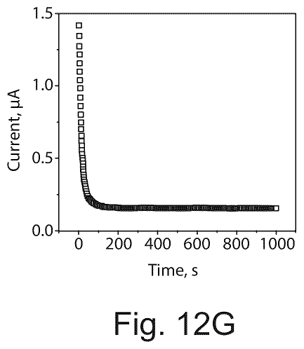

As indicated in FIG. 12, the LLZNTH samples have adequate ionic conductivity, although it is lower than the LLZT samples. The trend of the ionic conductivity of the LLZNTH sample is similar to the mechanical properties. At a sintering time of about 16 hours, the ionic conductivity reaches a peak number of about 4.67×10⁻⁴ S/cm. Further densification results in a decreased number. For the LLZT sample, the ionic conductivity increases with the increase of the sintering time and has a peak number of about 8.49×10⁻⁴ S/cm. The difference in the trend can be attributed to changes in the grain boundary morphologies. At a short sintering time of about 8 hours, the LLZT sample shows two semicircles at the high impedance range and the grain boundary resistance can be clearly observed from the spectrum. With a sintering of longer than about 12 hours, the impedance becomes a straight line which indicates a low grain boundary resistance. This can be attributed to the large grains in the LLZT samples with a long sintering time. The LLZNTH sample has a similar trend, but small semicircles can still be observed from the spectra. The LLZT sample also has a lower activation energy than the LLZNTH sample because of the higher conductivity. As a summary, the LLZNTH sample has sufficient ionic conductivity but is slightly lower than LLZT.

Electrochemical Properties of LLZNTH

Electrochemical characterizations including AC impedance spectra (dimensional nominalized) for ionic conductivity, Arrhenius plot for activation energy, and DC polarization plot for electrical conductivity of the sintered samples are shown in FIG. 12.

Referring to FIG. 12A to 12D, AC impedance spectra obtained at room temperature (about 23° C.) for the samples sintered at about 8 hours and about 12 hours show clear semicircles at high to medium frequencies and linear tail at low frequencies. As the sintering time increased to about 16 hours, the semicircle is disappearing, which is almost gone at the sintering time of about 20 hours. From the spectra, it is difficult to distinguish the bulk and grain boundary conductivity. Therefore, the diameter of the semicircle represents the total resistance (bulk and grain boundary) of the sintered electrolyte.

An equivalent circuit, (R₁Q₁)Q₂, where R is the resistance and Q is the constant phase element, was used to obtain the total ionic conductivity. As indicated in FIG. 12E, the ionic conductivity increases from about 0.76×10⁻⁴ S cm⁻¹ to about 4.67×10⁻⁴ S cm⁻¹ as the sintering time increases from about 8 hours to about 16 hours. Continuous increasing of the sintering time to about 20 hours decreases the conductivity to about 3.71×10⁻⁴ S cm⁻¹. Therefore, a sintering time of about 16 hours at a temperature of about 1100° C. is considered as the optional sintering condition for the sample.

Such conductivity results are consistent with the microstructure results as discussed above: (1) longer sintering time leads to higher relative density (increased from about 79% to 94%) and consequently higher ionic conductivity; (2) glass-like Li-rich compounds near the grain boundaries may significantly influence the ionic conductivity therefore the samples sintered at about 8 hours and about 12 hours have similar conductivity although the relative density increases (as well as the shape of the spectrum, thus, the disappearing of the semicircle may be due to the sufficient reaction/sintering); and (3) longer sintering above 16 hours may lead to further loss of the lithium which decreases the ionic conductivity.

The LLZNTH sample shows a promising ionic conductivity compared with prior art results. For instance, the most typical Li₇₋ₓLa₃Zr₂₋ₓTaₓO₁₂ (or similar level of Li content along with Al and/or Ta dopant) has an ionic conductivity in the range of about 3-9×10⁻⁴ S cm⁻¹. Such a range of ionic conductivity is sufficient for the lithium battery application. The current composition, which results in the relatively high ionic conductivity (about 4.67×10⁻⁴ S cm⁻¹), can be attributed to: (1) the four equimolar elements Zr, Nb, Ta, and Hf with different valences and atomic radii can maximize the Li-ion vacancy/deficiency and disordered Li sublattice, which can provide extra lithium ion transport pathways and consequently the high conductivity; and (2) the good stability of the cubic phase (at least 20 hours at a temperature of about 1100° C.), which was due to the proper selection of the dopants (consider supervalent doping of Nb(V) and Ta(V) to Zr(IV) and Hf(IV), which can stabilize the cubic phase), can maintain the high conductivity.

The impedance of the sample sintered at about 16 hours was further tested in the temperate range between room temperature (about 23° C.) and about 105° C. The Arrhenius plot of the results shown in FIG. 12F indicates an activation energy of about 0.25 eV, which is a relatively small value compared with prior art results due to the high ionic conductivity. The electrical conductivity for an ideal electrolyte is desirably low to prevent short circuitry and/or electrical leakage. The DC polarization plot of the sample shown in FIG. 12G shows a stable current after approximately 200 seconds and the conductivity is in the order of 10⁻⁸ S cm⁻¹, which is 4 orders of magnitude lower than the ionic conductivity. Such a low electrical conductivity of the LLZNTH sample indicates an ideal lithium conducting solid-state electrolyte.

The present invention of a high-entropy Li-garnet with multi elements in either the La site and/or the Zr site is significant for the application of lithium batteries. For example, the modification of the dopant may further increase the ionic conductivities by introducing more vacancies. Further, the variation of the dopants may modify the grain boundaries to prevent lithium penetration, increase the stability window between the electrolyte and electrode, and stabilize the interface between electrolyte and electrode. Also, the effects of high-entropy compounds, which means the introduction/modification of a single element, may significantly influence the final material properties, and can expand the capability of searching ideal solid-state electrolyte to fulfill the requirement of both electrochemical properties as well as other properties such as mechanical properties.

Thus, the high-entropy Li-garnet electrolyte of the present invention can expand the categories of such materials, improve the properties, and eventually the design of the materials with desired properties by modifying the dopants with the help of computational modeling.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What I claim is:

1. A solid-state battery comprising a Li-garnet ceramic electrolyte comprising:
a powder with a chemical composition of Li₇La₃Zr_{0.5}Nb_{0.5}Ta_{0.5}Hf_{0.5}O₁₂.

2. The battery of claim 1 wherein the powder has an entropy greater than 1.5 R.

3. The battery of claim 1 wherein the powder has a density of about 93-94% at a temperature of about 1100° C.

4. The battery of claim 1 wherein the powder has a fine grain size of about 1-10 nm.

5. The battery of claim 1 wherein Nb and Ta are of equimolar amounts on the Zr site.

6. The battery of claim 5 wherein Zr and Hf are of equimolar amounts on the Zr site.

7. The battery of claim 1 wherein the powder has a single cubic garnet phase (space group: Ia3̅d; No. 230) with uniform elements distributions.

8. The battery of claim 1 wherein the powder has an ionic conductivity of about 4.67×10⁻⁴ S cm⁻¹ at room temperature.

9. The battery of claim 1 wherein the powder has an activation energy of about 0.25 eV or less.

10. The battery of claim 1 wherein the powder has an electronic conductivity in the order of about 10⁻⁸ S cm⁻¹ or less.

11. The battery of claim 1 wherein the powder has a flexural strength of at least 84.8±6.9 MPa.

12. The battery of claim 1 wherein the powder has a hardness of at least 8.5±0.8 GPa.

13. A method of forming a solid-state battery comprising a Li-garnet ceramic electrolyte comprising:
ball milling LiOH·H₂O, La₂O₃, ZrO₂, Nb₂O₅, Ta₂O₅, and HfO₂ using milling media and liquid media to produce a mixture;
drying the mixture at a low temperature;
grounding the mixture;
molding the mixture into pellets; and
sintering the pellets at a high temperature;
wherein the high temperature is greater than the low temperature.

14. The method of claim 13 further comprising forming a powder with a chemical composition of Li₇La₃Zr_{0.5}Nb_{0.5}Ta_{0.5}Hf_{0.5}O₁₂.

15. The method of claim 14 wherein the particle size of the powder is about 1-10 μm.

16. The method of claim 13 further comprising calcinating the pellets at about 900° C. for at least 12 hours.

17. The method of claim 16 further comprising ball milling using zirconia milling media in IPA after the calcinating step to reduce particle size of the pellets.

18. The method of claim 13 wherein the milling media is zirconia and the liquid media is isopropyl alcohol (IPA).

19. The method of claim 13 wherein the drying of the mixture is at about 105° C. for 8 hours to 20 hours.

20. The method of claim 13 wherein the sintering of the mixture is at about 1100° C. for 8 hours to hours.
